(19) United States
(12) Patent Application Publication
(10) Pub. No.: US 2004/0205588 A1
(43) Pub. Date: Oct. 14, 2004

(54) System and method for dynamically generating a style sheet

(75) Inventors: Lisa S. Purvis, Fairport, NY (US); Steven J. Harrington, Webster, NY (US)

Correspondence Address: BASCH & NICKERSON LLP, 1777 PENFIELD ROAD, PENFIELD, NY, 14526, US

(73) Assignee: Xerox Corporation

(21) Appl. No.: 10/202,207

(22) Filed: Jul. 23, 2002

(51) Int. Cl. G06F 17/24; G06F 17/21; G06F 17/00; G06F 15/00

(52) U.S. Cl. 715/513

(57) ABSTRACT

What is disclosed is a system and method to generate a style sheet comprising the steps of first determining a set of layout constraints such as design criteria to act as ‘soft’ constraints or could additionally include the requirements of a particular output device. Alternatively, the constraints could be explicitly specified or expressed as properties of a good layout design. Next, the present method has the step of representing the style properties of the document as problem variables. These variables could advantageously include font, text line, or color properties in addition to positioning properties including graphical style. Then, solving the constraint problem and outputting the generated style properties in the form of a style sheet wherein the style sheet is a Cascaded Style Sheet (CSS) or an Extensible Style Language (XSL) specification.

### RELATED APPLICATIONS

Attention is directed to commonly owned and assigned copending Application Numbers:

U.S. Ser. No. ______ (not yet assigned), filed ______ (Atty. Docket D/A1456) entitled “CONSTRAINT-OPTIMIZATION SYSTEM AND METHOD FOR DOCUMENT COMPONENT LAYOUT GENERATION”.

U.S. Ser. No. ______ (not yet assigned), filed ______(Atty. Docket D/A1456Q) entitled “CONSTRAINT-OPTIMIZATION SYSTEM AND METHOD FOR DOCUMENT COMPONENT LAYOUT GENERATION”.

U.S. Ser. No. ______ (not yet assigned), filed ______ (Atty. Docket D/A1583) entitled “SYSTEM AND METHOD FOR CONSTRAINT-BASED DOCUMENT GENERATION”.

U.S. Ser. No. ______ (not yet assigned), filed ______ (Atty. Docket D/A1583Q) entitled “SYSTEM AND METHOD FOR CONSTRAINT-BASED DOCUMENT GENERATION”.

U.S. Ser. No. ______ (not yet assigned), filed ______(Atty. Docket D/A1586Q) entitled “SYSTEM AND METHOD FOR DYNAMICALLY GENERATING A STYLE SHEET”.

U.S. Ser. No. ______ (not yet assigned), filed ______ (Atty. Docket D/A1699) entitled “CASE-BASED SYSTEM AND METHOD FOR GENERATING A CUSTOM DOCUMENT”.

U.S. Ser. No. ______ (not yet assigned), filed ______ (Atty. Docket D/A1699Q) entitled “CASE-BASED SYSTEM AND METHOD FOR GENERATING A CUSTOM DOCUMENT”.

### FIELD OF THE INVENTION

The present invention is directed to systems and methods for generating style specifications for documents and, in particular, those systems and methods which use constraint-based approaches wherein style parameters of a document are problem variables, and layout and content requirements are expressed as constraints.

### BACKGROUND OF THE INVENTION

Style sheets provide a separation between document content and document style/layout information. By replacing or changing the style sheet, all web pages using that style sheet will change their rendering accordingly. This traditional use of a style sheet requires that the style sheet be created ahead of time by hand for a particular desired style. This style sheet can then be used to lay out varying sets of document content according to that style. The drawback of pre-determining style sheets is that the styling cannot easily be dynamic, changing with different output devices, or with different document content. Thus if different styles are required for different sets of content, or a different style for each output device, a style sheet is required for each scenario. This is problematic in terms of anticipating all potential scenarios, as well as a difficult maintenance problem.

Thus, what is needed in the art in order to eliminate the maintenance difficulties as well as the need to anticipate every possible scenario, is a means to automatically generate a style sheet based on the input content and the output device characteristics.

### SUMMARY OF THE INVENTION

What is disclosed is a system and method to generate a style sheet comprising the steps of first determining a set of layout constraints such as design criteria to act as ‘soft’ constraints or could additionally include the requirements of a particular output device. Alternatively, the constraints could be explicitly specified or expressed as properties of a good layout design. Next, the present method has the step of representing the style properties of the document as problem variables. These variables could advantageously include font, text line, or color properties in addition to positioning properties including graphical style. Then, solving the constraint problem and outputting the generated style properties in the form of a style sheet wherein the style sheet is a Cascaded Style Sheet (CSS) or an Extensible Style Language (XSL) specification. The system of the present invention advantageously comprises means for determining a set of layout constraints; means for representing the style properties of the document as problem variables; means for solving the constraint problem; and means for outputting the generated style properties in the form of a style sheet. Said means for solving the constraint problem comprise A system to generate a style sheet comprising means for determining a set of layout constraints; means for representing the style properties of the document as problem variables; means for solving the constraint problem; and means for outputting the generated style properties in the form of a style sheet.

### DETAILED DESCRIPTION OF THE INVENTION

What is disclosed is a system and method to generate a style sheet comprising the steps of first determining a set of layout constraints such as design criteria to act as ‘soft’ constraints or could additionally include the requirements of a particular output device. Alternatively, the constraints could be explicitly specified or expressed as properties of a good layout design. Next, the present method has the step of representing the style properties of the document as problem variables. These variables could advantageously include font, text line, or color properties in addition to positioning properties including graphical style. Then, solving the constraint problem and outputting the generated style properties in the form of a style sheet wherein the style sheet is a Cascaded Style Sheet (CSS) or an Extensible Style Language (XSL) specification.

The style parameters of a document are represented as a constraint satisfaction problem, and therefore comprise a set of variables, values, and constraints. The variables are any style parameters for the document that can be changed (e.g., font properties such as fontSize, text line properties such as linespacing, color properties such as colorantCost, positioning properties such as xPosition, and graphical style properties such as fillInk). The value domains for each of the variables are the range of potential values for each of the properties (e.g., fontSize can range from 8 to 65 points). The constraints are any layout and/or content requirements for the style (e.g., all backgrounds must contain one of set of specified background images, all widths for images must be less than 300 pixels).

In addition to these content and layout constraints, output device characteristics and/or properties can be specified as constraints. For example, if the output device happens to be a cell phone, its device characteristics might indicate that its display screen area is 2 cm. by 4 cm. This would mean that the problem has layout constraints that say each line of text can be a maximum of 2 cm. long, and that the number of lines of text per “page” must fit into 4 cm. The device characteristics also might indicate that the display screen resolution is not able to handle images, and, provided that the style sheet supported the selection of certain content, this would translate to a content constraint that specifies that only textual content can be included in the document.

If, on the other hand, the output device is a PDA, the device characteristics might indicate that the display screen resolution is able to handle both text and images of a certain low resolution, and thus the content constraint (if supported by the style sheet) would allow images of that resolution, and text. The device characteristics would also indicate that the PDA's display area is of a certain size (larger than that of the cell phone), and thus different layout constraints would be included in the problem that constrain the page width and height to this larger size.

Furthermore, design criteria can also be incorporated as desired constraints. Such constraints are not required to be satisfied in the final solution, but are preferences to be maximized if possible. Such desired constraints can be used to express properties of good layout design such as alignment (e.g., all object edges should be aligned), readability (e.g., lineLength should be <500, or linespacing should be >1.5), and turn the problem into a multi-criteria optimization problem.

Once the problem is modeled in this way as a constraint satisfaction or constraint optimization problem, one of the set of many existing constraint satisfaction/optimization algorithms can be used to find settings for the style properties that satisfy a particular set of constraints. The resulting style properties can be written out in the form of a style sheet. Note that this provides a method by which to dynamically generate a style sheet, since the style sheet can be generated once the output device properties and the content are known. One does not need a comprehensive set of style sheets for every output device beforehand.

The present invention has advantages over the current state-of-the-art of creating style sheets for each desired output style, in particular by providing a system and method by which to dynamically generate a style sheet once the output device properties and the content are known thereby eliminating the need for a comprehensive set of style sheets for every possible output device beforehand.

While the invention is described with reference to a particular embodiment, this particular embodiment is intended to be illustrative, not limiting. Various modifications may be made without departing from the spirit and scope of the invention as defined in the amended claims. Modifications and alterations will occur to others upon reading and understanding this specification; therefore, it is intended that all such modifications and alterations are included insofar as they come within the scope of the appended claims or equivalents thereof.

What is claimed is:

1. A method to generate a style sheet comprising the steps of:
a. representing the style properties of the document as problem variables;
b. determining a set of layout constraints on the variables;
c. solving the constraint problem; and
d. outputting the generated style properties in the form of a style sheet.

2. A method to generate a style sheet as defined in claim 1 further comprising the step of specifying design criteria to act as ‘soft’ constraints.

3. A method to generate a style sheet as defined in claim 1 wherein the layout constraints include the requirements of the output device.

4. A method to generate a style sheet as defined in claim 1 wherein the constraints may be explicitly specified.

5. A method to generate a style sheet as defined in claim 1 wherein the constraints express properties of good layout design.

6. A method to generate a style sheet as defined in claim 1 wherein the style sheet is a Cascaded Style Sheet (CSS).

7. A method to generate a style sheet as defined in claim 1 wherein the style sheet is an Extensible Style Language (XSL) specification.

8. A method to generate a style sheet as defined in claim 1 wherein the variables include font properties.

9. A method to generate a style sheet as defined in claim 1 wherein the variables include text line properties.

10. A method to generate a style sheet as defined in claim 1 wherein the variable include color properties.

11. A method to generate a style sheet as defined in claim 1 wherein the variable include positioning properties.

12. A method to generate a style sheet as defined in claim 1 wherein the variables include graphical style properties.
